(19) United States
(12) Patent Application Publication
(10) Pub. No.: US 2014/0304642 A1
(43) Pub. Date: Oct. 9, 2014

(54) SPECIFYING A LABEL FOR A COMPUTER APPLICATION

(71) Applicant: Paulo Schlup Santos, Minas Gerais (BR)

(72) Inventor: Paulo Schlup Santos, Minas Gerais (BR)

(73) Assignee: Google Inc.

(21) Appl. No.: 13/471,394

(22) Filed: May 14, 2012

(51) Int. Cl. G06F 3/048

(52) U.S. Cl. 715/780

(57) ABSTRACT

A computerized method and system for specifying a label for a computer application window, which, using a processing circuit, provides display data to represent a first display title in association with a field of the computer application window; receives an indication from a user that the user wishes to specify the label for the computer application window; provides a label-entry interface for the specifying of the label; receives a specified label from the user; and provides display data representing the specified label in association with the field. The computerized method and system further provides display data to represent the original display title and the specified label in association with an application icon; and further is capable of providing display data to represent the specified label in place of or in addition to the first display title in association with the field and/or the application icon.

### BACKGROUND

The present disclosure relates generally to labeling or tagging individual application windows.

Computer users use computer applications, for example a web browser, to access information stored on networks, such as intranets and internets, including the World Wide Web. Oftentimes, internet users open more than one internet browser windows in a single session. A user may choose to separate types of content by having a certain type of content in one internet browsing window, with a different type of content in a different browsing window. Currently, the display name of each browsing window corresponds to the title of the web page that is then-currently being displayed in the browsing window.

### SUMMARY

A computerized method and system for specifying a label for a computer application window. The computerized method and system provides display data, using a processing circuit, to represent a first display title in association with a field of the computer application window; receives, by the processing circuit, an indication from a user from a user interface that the user wishes to specify the label for the computer application window; provides, by the processing circuit, a label-entry interface for the specifying of the label; receives, by the processing circuit, a specified label from the user; and provides display data, by the processing circuit, representing the specified label in association with the field. The computerized method and system further provides display data, by the processing circuit, to represent the original display title in association with an application icon; and provides display data, by the processing circuit, to represent the specified label in association with the application icon. The computerized method and system is capable of providing display data to represent the specified label in place of or in addition to the first display title in association with the field and/or the application icon.

These implementations are mentioned not to limit or define the scope of this disclosure, but to provide examples of implementations to aid in understanding thereof.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a block diagram of a computer system in accordance with a described implementation;

FIG. 2 is an illustration of an example display showing two illustrative browser windows;

FIG. 3.a is an illustrative depiction of a window application title in accordance with a described implementation;

FIG. 3.b is an illustrative depiction of a dialogue box in accordance with a described implementation;

FIG. 3.c is an illustrative depiction of a browser window and an application toolbar in accordance with a described implementation;

FIG. 4 is a block diagram of an example computer network environment; and

FIG. 5 is an example computing device in accordance with a described implementation.

Like reference numbers and designations in the various drawings indicate like elements.

### DETAILED DESCRIPTION OF THE ILLUSTRATIVE IMPLEMENTATIONS

Implementations of the systems and methods for allowing a computer user to specify a name for individual browser windows are described herein. Allowing the user to specify a name for each browser window may assist the user to organize internet navigation, internet documents, or internet applications according to the specified name in any way that the user deems appropriate. Another implementation is a system for allowing the user to specify a name for each browser window when multiple navigational tabs are used in a single browser window. These implementations of the systems and methods can also be applied to other computer applications besides a web browser for accessing information stored on a network. These implementations of the systems and methods can further be applied to other computer applications that are used for other purposes besides accessing information stored on a network, such as, for example, word processing applications, spreadsheet applications, entertainment applications, accounting applications, musical applications, media applications, etc. While this specification describes implementations with reference to a web browser, the corollary components of any other computer application are contemplated by this specification.

Another implementation is a system for allowing the user to specify a name for each browser window, where the specified name is shown in the application icon of the application toolbar of the computer operating system, the window application title, or in both of these locations. A further implementation is a system for allowing the user to specify a name for each browser window, where the specified name as well as the name of the web page that is currently active in the browser navigational tab are concurrently shown in the application icon of the application toolbar of the computer operating system, the browser window application title, or in both of these locations. Still further implementations allow the user to specify the font of the specified name, apply a color to the specified name (either color of text or color of the text's background), and/or to apply a “skin” or color package to the application windows. Another implementation is a system for allowing the user to specify an image or avatar name for each browser window in addition or in lieu of specifying a name.

The user may wish to specify a name for each computer application window according to the content of the window, according to the time when the user opened the windows, etc. Providing the user with the ability to specify a name for the windows allows the user to organize the windows in a more user-friendly manner.

When using a web browser, such as Microsoft Internet Explorer or Mozilla Firefox, a user requests a web page using known methods (e.g., by entering the destination of the content page into the web browser, clicking a link from a different content page or a search page, choosing a stored bookmark, etc.). A publisher serving engine or server provides the information for the networks, including web pages, and an ad serving engine provides the content ad for rendering on the web-pages.

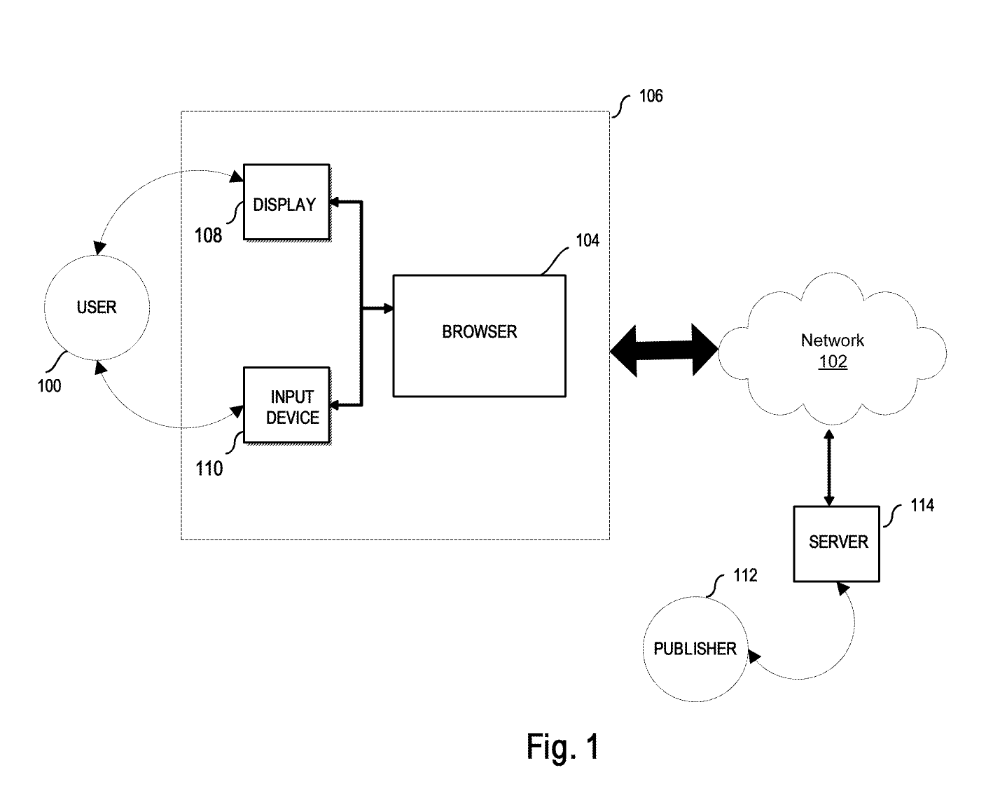

Referring to FIG. 1, a user 100 is able to view the information of network 102 using a browser 104. The browser 104 is part of a user device 106, which also includes a display 108 and a user interface 110, among other components.

The process of providing information through a network begins by a publisher 112 producing data and metadata that can be rendered on web pages of web sites. The publisher's web pages and web sites are stored on a computer medium, such as a server 114, and are provided to a requesting user through the network 102. When requested by a user 100, the server 114, on which the web pages and web sites are stored, transmits the data and the metadata for the web pages and web sites to the browser 104 through the network 102.

When the user 100 requests a web page of the web site using an input device 110 to the browser 104, the browser 104 requests the web page of the web site of the server 114 to be rendered on the browser 104 via the network 102. The server 114 will return the web page of the web site to the browser 104 for rendering on the display 108.

A user interface provides the user with the ability to specify a name for individual application windows, including browser windows in the case where the application is a web browser application. The user interface may be a clickable badge or icon beside the window application title, for example. The user interface could be any different shape or icon, for example, an arrow, a circle, a button, etc. A user could interact with the user interface in a variety of ways, including but not limited to a mouse-over, click, double-click, by hovering the cursor on the user interface for a predetermined period of time, etc. When the user interacts with the user interface, the user interface could then become a different color, could be shown as a different badge or icon, could no longer be shown, etc.

When a user interacts with the user interface, a dialogue box is generated. The dialogue box would provide the user with the ability to specify a name for the application window. As further described herein, in some implementations, the dialogue box may also provide the user with the ability to specify a font for the name, an image or avatar, and/or a “skin” or color package. The dialogue box could also provide the user with the ability to maintain general settings for the process of specifying a name for the application window. The settings could include, among other options, whether the original window name is shown along with the specified name, whether the application should automatically suggest a name, etc.

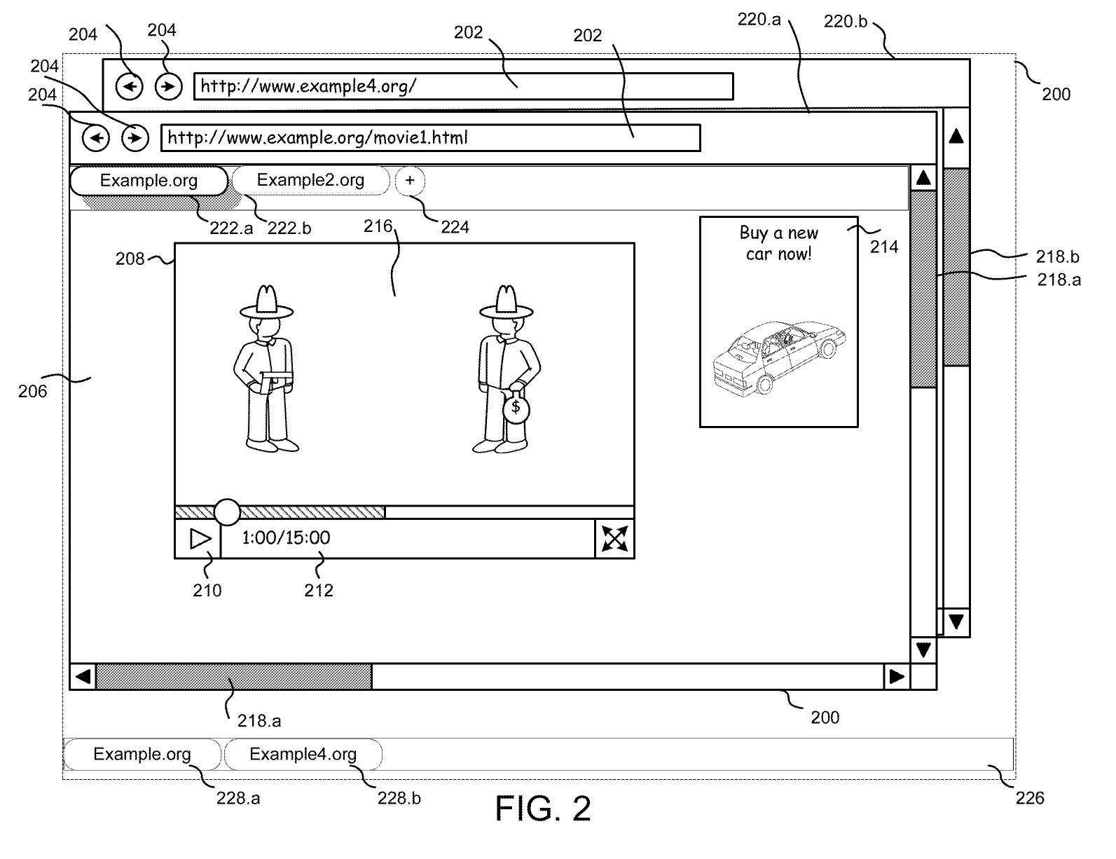

Referring now to FIG. 2, an example display 200 is shown. Display 200 is in electronic communication with one or more processors that cause visual indicia to be provided on display 200. Display 200 may be located inside or outside of the housing of the one or more processors. For example, display 200 may be external to a desktop computer (e.g., display 200 may be a monitor), may be a television set, or any other stand-alone form of electronic display. In another example, display 200 may be internal to a laptop computer, mobile device, or other computing device with an integrated display.

As shown in FIG. 2, the one or more processors in communication with display 200 may execute a browser application (e.g., display 200 is part of a user device) that generates a browser window 220.a. The browser application operates by receiving input of a uniform resource locator (URL) into a text field 202, such as a web address, from an input device (e.g., a pointing device, a keyboard, a touchscreen, or another form of input device). In response, one or more processors executing the web browser may request data from a content source corresponding to the URL via a network (e.g., the Internet, an intranet, or the like). The content source may then provide web page data and/or other data to the client device, which causes visual indicia to be displayed by display 200.

In general, web page data may include text, hyperlinks, layout information, and other data that is used to provide the framework for the visual layout of displayed web page 206. In some implementations, web page data may be one or more files of webpage code written in a markup language, such as the hypertext markup language (HTML), extensible HTML (XHTML), extensible markup language (XML), or any other markup language. For example, the web page data in FIG. 2 may include a file, “movie1.html” provided by the website, “www.example.org.” The web page data may include data that specifies where indicia appear on webpage 206, such as movie 216 or other visual objects. In some implementations, the webpage data may also include additional URL information used by the client device to retrieve additional indicia displayed on web page 206. For example, the file, “movie1.html,” may also include one or more advertisement tags used to retrieve advertisement 214 from a remote location (e.g., an advertisement server, the content source that provides webpage 206, etc.) and to display advertisement 214 on display 200.

The web browser providing data to display 200 may include a number of navigational controls associated with web page 206. For example, the web browser may include the ability to go backward or forward to other web pages using inputs 204 (e.g., a back button, a forward button, etc.). The web browser may also include one or more scroll bars 218.a, which can be used to display parts of web page 206 that are currently off-screen. For example, web page 206 may be formatted to be larger than the screen of display 200. In such a case, one or more scroll bars 218 may be used to change the vertical and/or horizontal position of webpage 206 on display 200. The web browser may also be capable of providing navigational tabs 222. A user can open an additional web page 206 in a navigational tab 222 and can open multiple navigational tabs 222 in one browser window 220. The user opens an additional navigational tab 222 by interacting with a user interface icon 224. Navigational tabs typically list the title of the web page that is open in the tab. For example, navigational tab 222.a lists the title of the web page open in that navigational tab, “example.org,” while navigational tab 222.b lists the title of the web page open in that navigational tab, “example2.org.” A browser application may also be configurable to provide some indication of which tab is currently selected. For example, the browser application may apply a different color to the selected navigational tab than the non-selected navigational tabs. The example shown in FIG. 2 utilizes a drop-shadow on the selected navigational tab 222.a to indicate that navigational tab 222.a is currently selected by the user.

The name of the currently active web page may be shown in the window application title and in the application icon of the application toolbar. For computer applications that do not support navigational tabs, the active web page is the web page that is shown in the application window. For computer applications that do support navigational tabs, the active web page is the web page that corresponds to the currently selected navigational tab.

In one example, additional data associated with web page 206 may be configured to perform any number of functions associated with movie 216. For example, the additional data may include a media player 208, which is used to play movie 216. Media player 208 may be called in any number of different ways. In one implementation, media player 208 may be an application installed on the client device and launched when web page 206 is rendered on display 200. In another implementation, media player 208 may be part of a plug-in for the web browser. In another implementation, media player 208 may be part of the web page data downloaded by the client device. For example, media player 208 may be a script or other form of instruction that causes movie 216 to play on display 200. Media player 208 may also include a number of controls, such as a button 210 that allows movie 216 to be played or paused. Media player 208 may include a timer 212 that provides an indication of the current time and total running time of movie 216.

The various functions associated with advertisement 214 may be implemented by including one or more advertisement tags within the web page code located in “movie1.html” and/or other files. For example, “movie1.html” may include an advertisement tag that specifies that an advertisement slot is to be located at the position of advertisement 214. Another advertisement tag may request an advertisement from a remote location, for example, from an advertisement server, as webpage 206 is loaded. Such a request may include client identification data (e.g., a cookie, device ID, etc.) used by the advertisement server as a user identifier. In this way, the advertisement server is able to determine browsing history associated with a user identifier as it is used to navigate between various web pages that participate in the advertising network (e.g., web pages that include advertisements from the advertisement server).

In some implementations, a user may operate the browser application to open more than one browser window 220.a and 220.b, for example, to retrieve and/or view multiple web pages at the same time or to have multiple web pages open at one time. Each browser window 220.a and 220.b may operate in a similar manner as described above, may contain similar attributes as described above, and may be capable of displaying similar types of web pages as described above. While FIG. 2 shows two open browser windows 220.a and 220.b, opening more than two browser windows, up to an allowed maximum as specified by the browser application, is also possible.

The user device also includes an operating system that manages the various applications that are executed on the user device. For example, the applications could include the browser application, a word processing application, a spreadsheet application, etc. The operating system typically also includes an application toolbar 226. The application toolbar 226 provides the display with data that informs the user of which applications are currently open. The currently open applications are shown in the application toolbar 226 as application icons 228. For browser applications, the title of the web page that is open in the browser window is shown in the application icon. When multiple navigational tabs are used by the user, the title of the web page that is open in the currently selected navigational tab of the browser window is shown in the application icon 228. For example, application icon 228.a shows the title of the web page that is open in the currently selected navigational tab of browser window 220.a, “example.org”, while application icon 228.b shows the title of the web page that is open in the currently selected navigational tab of the browser window 220.b, “example4.org.”

When a user operates the browser application to open more than one browser window 220, it may become difficult for a user to identify in which browser window 220 a particular web page is. As shown in FIG. 2, when multiple browser windows are open, some or all portions of a browser window may not be visible to the user—as is the case with browser window 220.b. This is especially true if the user opens many navigation tabs 222, as the application icon does not provide all of the titles of the tabs open in one browser window but instead uses the title of the currently selected navigational tab as the display name in the application icon. The title of the currently selected navigational tab is also shown as the display name in the application icon when the browser window is minimized. When a user minimizes a browser window, it is especially difficult for the user to identify what other web pages a window contains in the other navigational tabs without un-minimizing or otherwise enlarging the browser window.

In some implementations, the browser is configured so that a user is able to specify a name for an individual browser window. The specified name would be shown in the application icon instead of the title of the currently selected navigational tab. Allowing the user to specify a name for an individual browser window would allow the user to organize internet navigation, documents, and/or web pages in a specified manner, for example according to the subject matter of the set of tabs in the individual browser window.

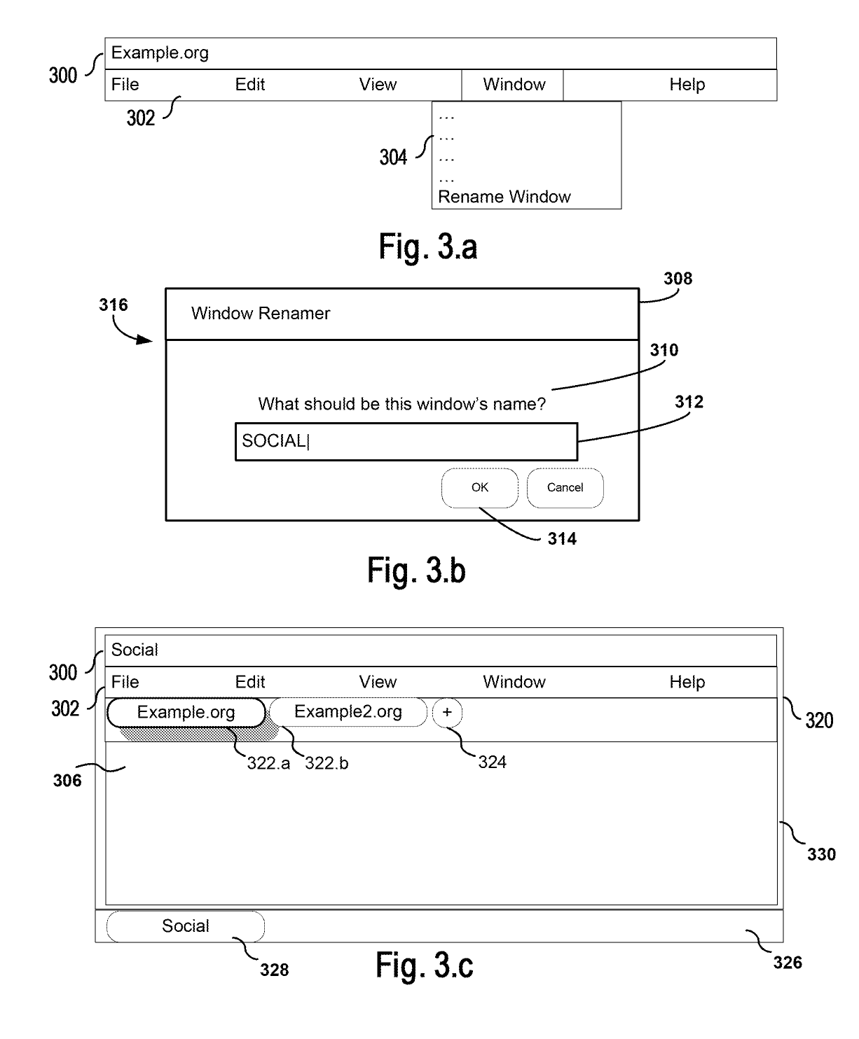

In some implementations, as shown in FIG. 3.a, the browser is configured with a window application title 300 and a browser application toolbar 302. The window application title 300 shows the name of the web page that is currently shown in the browser window, where the name corresponds also to the application icon. The browser application toolbar 302 includes an option that allows the user to specify the name of an individual browser window. For example, the browser application toolbar includes “File,” “Edit,” “View,” “Window,” and “Help” options and within the “Window” option a “Rename Window” sub-option is provided among other sub-options. When a user interacts with the “Window” option, a dropdown window 304 is shown, where the dropdown window displays the available sub-options, including the “Rename Window” sub-option. When the user selects the “Rename Window” sub-option the user is provided with the ability to specify the name of the browser window. While one example of how a user could interact with the browser to be provided with the ability to specify the name of the browser windows has been described, other methods of user interaction with the browser are also contemplated, including but not limited to a rename icon, a keyboard shortcut, a moving of the “Rename Window” sub-option to a different browser application toolbar option, a voice command, etc.

When the user interacts with the browser so that the user is provided with the ability to specify the name of the browser window, the browser provides the user with a text field or other input field so that the user may enter a specified name for the browser window. For example, a dialogue box, which includes a text field, could “pop-up” on the display, the application icon associated with the browser application could be used as the text field, etc.

FIG. 3.b is an example a “pop-up” dialogue box 316 for providing the user with a text field 312 so that the user may enter a specified name for the browser window. When the user interacts with the browser in a way that indicates that the user wishes to specify a name for the browser window, dialogue box 316 pops-up and is shown on the display. Dialogue box 316 includes, among other potential components, a dialogue box title 308 for providing the title of the dialogue box, a prompt 310 for informing the user of the action to be taken, a text field 312 for entering the specified name, and a confirmation button 314 for allowing the user to confirm the action of specifying a name for the browser window.

In some implementations, as shown in FIG. 3.c, when the user confirms the specifying of a name or label for the browser window 320, the specified name is shown in, near, adjacent or otherwise in association with the application icon 328 of the application toolbar 326, the window application title 300, or both. In some implementations, the specified name is shown and the name of the currently active web page 306 of the browser window 320 is no longer shown. In some implementations, the specified name is shown along with the name of the currently active web page 306 of the browser window 320.

For the implementation shown in FIG. 3.c, the currently active navigational tab corresponds to the web page, “Example.org.” If the user has a social media web page open in the browser window or in the one or more navigational tabs open in a browser window, the user may desire to specify the name, “Social,” for this particular browser window. In this example, the user would input the specified name, “Social,” in the text field 312. Once the user confirms the action of specifying the name, “Social” would appear as the name shown in the application icon 328 of the application toolbar 326, in the window application title 300, or in both. The specified name, “Social,” would appear instead of the name, “Example.org,” that was originally shown. In some applications, the specified name and the original name would both be shown, for example, “Social—Example.org” would be shown. The system could be configured to place the specified name in brackets, to put a colon, hyphen, or other character between the specified name and the original name, etc.

Typically, a computer application developer specifies a character font of the text displayed in the application icon of the application toolbar, in the window application title, and in navigational tabs, for applications that support navigational tabs (“Original Font”). In some implementations, the specified name, when shown in the application icon in the application toolbar and/or in the window application title, is in the same character font as the Original Font. In some implementations, the browser developer could specify a character font for the specified name when used (“Specified Font”), which could be different from the Original Font. Further, in some implementations, the browser developer could provide a method for the user to specify a character font of the specified name. The browser developer or the user could use any of the known ways to specify and/or change the text of a character font, including but not limited to different text fonts, different font color, different background color, etc.

If the name of the web page 306 that is currently active in the browser window 320 is shown along with the specified name in the application icon 328 of the application toolbar 326 and/or in the window application title 300, the font variations described could also be applied to the name of the active web page. The browser developer and/or the user may choose to make the character font of the specified name the same as the character font of the name of the active web page. Further, in some implementations, the browser developer and/or the user may choose to make the character font of the specified name different than the character font of the name of the active web page.

In some implementations, the user would have the option to choose an image or avatar instead of or in addition to a name using text characters. Additionally, the variations described above are also contemplated for implementations where the user has the option to choose an image or avatar. For example, the text of the active web page could still be changed from the Original Font, borders or shading could be added to the image or avatar, and the image or avatar would be shown in the application icon 328 of the application toolbar 326 and/or in the window application title 300.

In some implementations, the user would have the option to choose a “skin” or color package for individual windows of the computer application. In these implementations, the user is able to select a color or pattern for an individual application window, where the color or pattern would be applied to the application icon 328 of the application toolbar 326, the window application title 300, the window application border 330, or some combination thereof.

In some implementations, the specified name, image or avatar, and/or “skin” or color package for an individual application window is automatically suggested by the computer application, based on tags, metadata, and/or cookies associated with the contents of the individual application window.

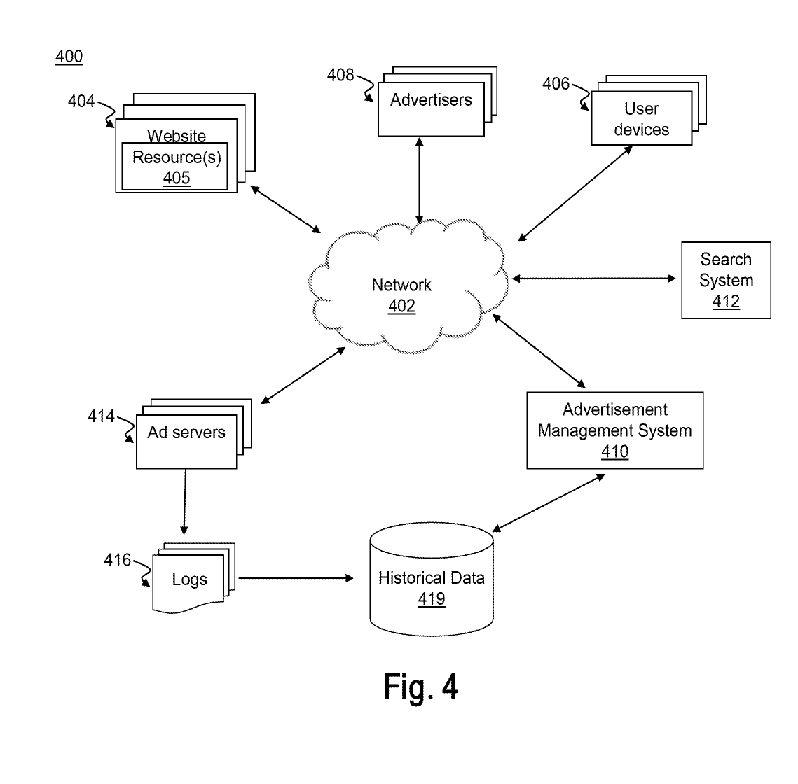

FIG. 4 is a block diagram of an example environment 400 in which user devices connect to a network 402 in accordance with an illustrative implementation. The example environment 400 includes the network 402, such as a local area network (LAN), a wide area network (WAN), the Internet, or a combination thereof. The network 402 connects websites 404, user devices 406, advertisers 408, and an advertisement management system 410. The example environment 400 may include many thousands of websites 404, user devices 406, and advertisers 408.

A website 404 includes one or more resources 405 associated with a domain name and hosted by one or more servers. An example website is a collection of web pages formatted in hypertext markup language (HTML) that can contain text, images, multimedia content, and programming elements, such as scripts. A specific example website is a website that contains calendar information for a particular user.

A resource 405 is any data that can be provided over the network 402. For example, user calendar and specific calendar events are examples of resources. A resource 405 can be identified by a resource address that is associated with the resource 405, such as a uniform resource locator (URL). Resources 405 can include web pages, word processing documents, portable document format (PDF) documents, images, video, programming elements, interactive content, and feed sources, to name only a few. The resources 405 can include content, such as words, phrases, images and sounds, that may include embedded information (such as meta-information in hyperlinks) and/or embedded instructions. Embedded instructions can include code that is executed at a user's device, such as in a web browser. Code can be written in languages such as JavaScript® or ECMAScript®.

A user device 406 is an electronic device that is under control of a user and is capable of requesting and receiving resources 405 over the network 402. Example user devices 406 include personal computers, mobile communication devices, and other devices that can send and receive data over the network 402. A user device 406 typically includes a user application, such as a web browser, to facilitate the sending and receiving of data over the network 402.

A user device 406 can request resources 405 from a website 404. In turn, data representing the resource 405 can be provided to the user device 406 for presentation by the user device 406. The data representing the resource 405 can include data specifying a portion of the resource or a portion of a user display (e.g., a presentation location of a pop-up window or in a slot of a web page) in which advertisements can be presented. These specified portions of the resource 405 or user display are referred to as advertisement slots.

To facilitate searching of the vast number of resources 405 accessible over the network 402, the environment 400 can include a search system 412 that identifies the resources 405 by crawling and indexing the resources 405 provided on the websites 404. Data about the resources 405 can be indexed based on the resource 405 with which the data is associated. The indexed and, optionally, cached copies of the resources 405 are stored in a search index (not shown).

User devices 406 can submit search queries to the search system 412 over the network 402. In response, the search system 412 accesses the search index to identify resources 405 that are relevant to the search query. In one illustrative implementation, a search query includes one or more keywords. The search system 412 identifies the resources 405 that are responsive to the query, provides information about the resources 405 in the form of search results and returns the search results to the user devices 406 in search results pages. A search result can include data generated by the search system 412 that identifies a resource 405 that is responsive to a particular search query, and can include a link to the resource 405. An example search result can include a web page title, a snippet of text or a portion of an image extracted from the web page 404, a rendering of the resource 405, and the URL of the web page 404. Search results pages can also include one or more advertisement slots in which advertisements can be presented.

A search result page or a content page can be sent with a request from the search system 412 for the web browser of the user device 406 to set an HTTP (HyperText Transfer Protocol) cookie. A cookie can represent, for example, a particular user device 406 and a particular web browser. For example, the search system 412 includes a server that replies to the query by sending the search results page in an HTTP response. This HTTP response includes instructions (e.g., a set cookie instruction) that cause the browser to store a cookie for the site hosted by the server or for the domain of the server. If the browser supports cookies and cookies are enabled, every subsequent web page request to the same server or a server within the domain of the server will include the cookie. The cookie can store a variety of data, including a unique or semi-unique identifier. The unique or semi-unique identifier can be anonymized and is not connected with user names. Because HTTP is a stateless protocol, the use of cookies allows an external service, such as the search system 412 or other system, store information over multiple sessions. A user may prevent such information storage, for example, by disabling cookies in the browser's settings.

When a resource 405 or search results are requested by a user device 406 or provided to the user device 406, the advertisement management system 410 receives a request for advertisements to be provided with the resource 405 or search results. The request for advertisements can include characteristics of the advertisement slots that are defined for the requested resource 405 or search results page, and can be provided to the advertisement management system 410. For example, a reference (e.g., URL) to the resource 405 for which the advertisement slot is defined, a size of the advertisement slot, and/or media types that are available for presentation in the advertisement slot can be provided to the advertisement management system 410. Similarly, keywords (i.e., one or more words that are associated with content) associated with a requested resource 405 (“resource keywords”) or a search query for which search results are requested can also be provided to the advertisement management system 410 to facilitate identification of advertisements that are relevant to the resource 405 or search query. In addition, various other data such as, but not limited to, keywords generated from calendar entries can also be accessed by or provided to the advertisement management system 410.

Based on data included in the request for advertisements, the advertisement management system 410 can select advertisements that are eligible to be provided in response to the request (“eligible advertisements”). For example, eligible advertisements can include advertisements having characteristics matching the characteristics of advertisement slots and that are identified as relevant to specified user interests based upon a user's calendar entries. In some implementations, advertisements having targeting keywords that match a user's interests, the resource keywords, the search query, or portions of the search query are selected as eligible advertisements by the advertisement management system 410.

The advertisement management system 410 selects an eligible advertisement for each advertisement slot of a resource 405 or of a search results page. The resource 405 or search results page is received by the user device 406 for presentation by the user device 406. User interaction data representing user interactions with presented advertisements can be stored in a historical data store 419. For example, when an advertisement is presented to the user via an ad server 414, data can be stored in a log file 416. This log file 416, as more fully described below, can be aggregated with other data in the historical data store 419. Accordingly, the historical data store 419 contains data representing the advertisement impression. For example, the presentation of an advertisement is stored in response to a request for the advertisement that is presented. For example, the ad request can include data identifying a particular cookie, such that data identifying the cookie can be stored in association with data that identifies the advertisement(s) that were presented in response to the request. In some implementations, the data can be stored directly to the historical data store 419.

Similarly, when a user selects (i.e., clicks) a presented advertisement, data representing the selection of the advertisement can be stored in the log file 416, a cookie, or the historical data store 419. In some implementations, the data is stored in response to a request for a web page that is linked to by the advertisement. For example, the user selection of the advertisement can initiate a request for presentation of a web page that is provided by (or for) the advertiser. The request can include data identifying the particular cookie for the user device, and this data can be stored in the advertisement data store.

User interaction data can be associated with unique identifiers that represent a corresponding user device with which the user interactions were performed. For example, in some implementations, user interaction data can be associated with one or more cookies. Each cookie can include content which specifies an initialization time that indicates a time at which the cookie was initially set on the particular user device 406.

The log files 416, or the historical data store 419, also store references to advertisements and data representing conditions under which each advertisement was selected for presentation to a user. For example, the historical data store 419 can store targeting keywords, bids, and other criteria with which eligible advertisements are selected for presentation. Additionally, the historical data store 419 can include data that specifies a number of impressions for each advertisement and the number of impressions for each advertisement can be tracked, for example, using the keywords that caused the advertisement impressions and/or the cookies that are associated with the impressions. Data for each impression can also be stored so that each impression and user selection can be associated with (i.e., stored with references to and/or indexed according to) the advertisement that was selected and/or the targeting keyword that caused the advertisement to be selected for presentation.

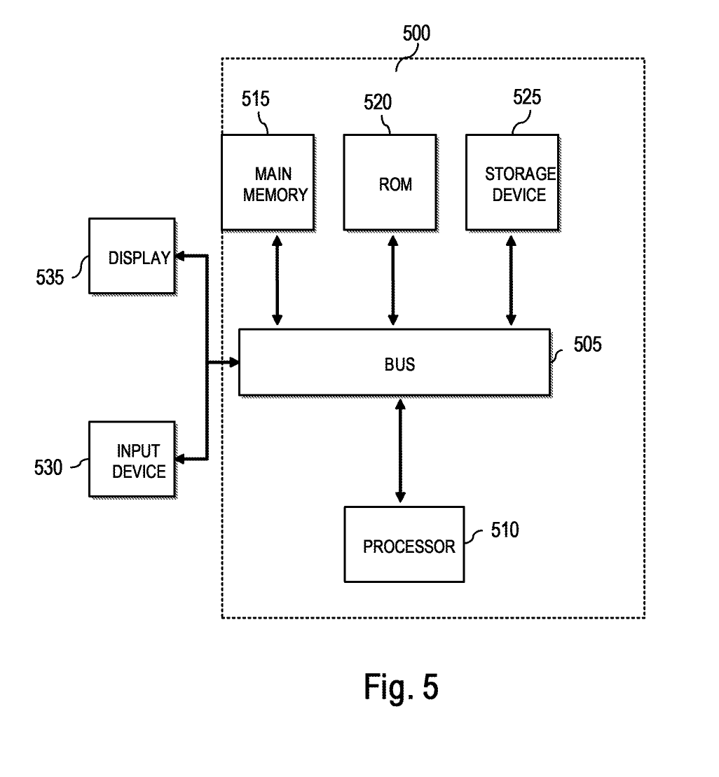

FIG. 5 is a block diagram of a computer system in accordance with an illustrative implementation. The computer system or computing device 500 can be used to implement one or more computer applications, a user device 406, etc. The computing system 500 includes a bus 505 or other communication component for communicating information and a processor 510 coupled to the bus 505 for processing information. The computing system 500 also includes main memory 515, such as a random access memory (RAM) or other dynamic storage device, coupled to the bus 505 for storing information, and instructions to be executed by the processor 510. Main memory 515 can also be used for storing position information, temporary variables, or other intermediate information during execution of instructions by the processor 510. The computing system 500 may further include a read only memory (ROM) 510 or other static storage device coupled to the bus 505 for storing static information and instructions for the processor 510. A storage device 525, such as a solid state device, magnetic disk or optical disk, is coupled to the bus 505 for persistently storing information and instructions.

The computing system 500 may be coupled via the bus 505 to a display 535, such as a liquid crystal display, or active matrix display, for displaying information to a user. An input device 530, such as a keyboard including alphanumeric and other keys, may be coupled to the bus 505 for communicating information and command selections to the processor 510. In another implementation, the input device 530 has a touch screen display 535. The input device 530 can include a cursor control, such as a mouse, a trackball, or cursor direction keys, for communicating direction information and command selections to the processor 510 and for controlling cursor movement on the display 535.

According to various implementations, the processes described herein can be implemented by the computing system 500 in response to the processor 510 executing an arrangement of instructions contained in main memory 515. Such instructions can be read into main memory 515 from another computer-readable medium, such as the storage device 525. Execution of the arrangement of instructions contained in main memory 515 causes the computing system 500 to perform the illustrative processes described herein. One or more processors in a multi-processing arrangement may also be employed to execute the instructions contained in main memory 515. In alternative implementations, hard-wired circuitry may be used in place of or in combination with software instructions to implement illustrative implementations. Thus, implementations are not limited to any specific combination of hardware circuitry and software.

Although an example computing system has been described in FIG. 5, implementations of the subject matter and the functional operations described in this specification can be implemented in other types of digital electronic circuitry, or in computer software embodied on a tangible medium, firmware, or hardware, including the structures disclosed in this specification and their structural equivalents, or in combinations of one or more of them.

Implementations of the subject matter described in this specification can be implemented as one or more computer programs, i.e., one or more modules of computer program instructions, encoded on one or more computer storage media for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be implemented as operations performed by a data processing apparatus on data stored on one or more computer-readable storage devices or received from other sources.

The term “client,” “server,” “data processing apparatus,” and/or “computing device” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

The features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services (e.g., Netflix, Vudu, Hulu, etc.), a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate embodiments, the features may be implemented on a laptop computer or other personal computer, a smartphone, other mobile phone, handheld computer, a tablet PC, or other computing device.

A computer application (also known as a program, a computer program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors or processing circuits executing one or more computer programs to perform actions by operating on input data and generating output. The processes and logic flows can also be performed by, and apparatus can also be implemented as, special purpose logic circuitry, e.g., an FPGA or an ASIC.

Processors or processing circuits suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), OLED (organic light emitting diode), TFT (thin-film transistor), plasma, other flexible configuration, or any other monitor for displaying information to the user and a keyboard, a pointing device, e.g., a mouse, trackball, etc., or a touch screen, touch pad, etc., by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface (GUI) or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

While the above description contains many specifics, these specifics should not be construed as limitations on the scope of the invention, but merely as exemplifications of the disclosed implementations. Those skilled in the art will envision many other possible variations that are within the scope of the invention as defined by the claims appended hereto.

1. A computerized method for specifying a label for a web browser application window comprising:
providing display data, using a processing circuit, to represent a first display title in association with a field of the web browser application window;
receiving, by the processing circuit, an indication from a user from a user interface that the user wishes to specify the label for the web browser application window;
providing, by the processing circuit, a label-entry interface for the specifying of the label, wherein the label-entry interface comprises an image input portion and is configured to allow the user to specify any of a text label, an image label, or a combined text and image label as a specified label;
receiving, by the processing circuit, the specified label from the user; and
providing display data, by the processing circuit, representing the specified label in association with the field.

2. The method of claim 1, wherein the providing display data representing the specified label in association with the field further comprises providing display data to represent the specified label in place of the original display title.

3. The method of claim 1, wherein the providing display data representing the specified label in association with the field further comprises providing display data to represent the specified label in addition to the original display title.

4. The method of claim 1, wherein the specifying the label for the web browser application window further comprises:
providing display data, by the processing circuit, to represent the original display title in association with an application icon; and
providing display data, by the processing circuit, to represent the specified label in association with the application icon.

5. The method of claim 4, wherein the providing display data representing the specified label in association with the application icon further comprises providing display data to represent the specified label in place of the original display title.

6. The method of claim 4, wherein the providing display data representing the specified label in association with the application icon further comprises providing display data to represent the specified label in addition to the original display title.

7. The method of claim 1, wherein receiving the specified label from the user further comprises receiving at least one of a text input or an image input as the specified label.

8. The method of claim 7, wherein receiving the specified label from the user further comprises receiving a font characteristic of the text input from the user.

9. The method of claim 1, wherein receiving the specified label from the user further comprises receiving a color selection for the web browser application window.

10. A system for specifying a label for a web browser application window comprising a processing circuit operable to:
provide display data for a first display label in a first field of the web browser application window;
receive an indication from a user at a user interface that the user wishes to specify the label for the web browser application window;
provide a label-entry interface for the specifying of the label, wherein the label-entry interface comprises an image input portion and is configured to allow the user to specify any of a text label, an image label, or a combined text and image label as a specified label;
receive the specified label from the user; and
provide display data to represent the specified label in the first field.

11. The system of claim 10, wherein the processing circuit provides display data to represent the specified label in place of the first display label.

12. The system of claim 10, wherein the processing circuit provides display data to represent the specified label in addition to the first display label.

13. The system of claim 10, wherein the processing circuit is further operable to:
provide display data for a second display label in a second field; and
provide display data to represent the specified label in the second field.

14. The system of claim 13, wherein the processing circuit provides display data to represent the specified label in place of the second display label.

15. The system of claim 13, wherein the processing circuit provides display data to represent the specified label in addition to the second display label.

16. The system of claim 10, wherein the specified label received from the user comprises at least one of a text input or an image input.

17. The system of claim 16, wherein the specified label received from the user further comprises a font characteristic of the text input.

18. An apparatus for specifying a label for a web browser application window, the apparatus comprising:
means for providing display data to represent a first display title in association with an at least one field associated with the web browser application window;
means for receiving an indication from a user from a user interface that the user wishes to specify the label for the web browser application window;
means for providing a label-entry interface for the specifying of the label, wherein the label-entry interface comprises an image input portion and is configured to allow the user to specify any of a text label, an image label, or a combined text and image label as a specified label;
means for receiving the specified label from the user; and
means for providing display data representing the specified label in association with the at least one field associated with the computer application window.

19. The apparatus of claim 18, wherein the apparatus further comprises means for receiving an indication from the user of whether the means for providing display data representing the specified label should provide display data representing the specified label in place of the first display title or in addition to the first display title.

20. The apparatus of claim 18, wherein means for providing the label-entry interface for the specifying of the label comprises means for receiving from the user at least one of a text input or an image input as the specified label.

21. The method of claim 1, further comprising automatically providing a suggestion for the specified label based on data associated with the contents of the web browser application window.
